(19) United States
(12) Patent Application Publication
(10) Pub. No.: US 2008/0042783 A1
(43) Pub. Date: Feb. 21, 2008

(54) Filter

(76) Inventors: Jarmo Makinen, Vallentuna (SE); Anders Svensson, Djursholm (SE)

Correspondence Address: MYERS DAWES ANDRAS & SHERMAN, LLP, 19900 MACARTHUR BLVD.,, SUITE 1150, IRVINE, CA, 92612, US

(21) Appl. No.: 11/665,692

(22) PCT Filed: Oct. 14, 2005
(86) PCT No.: PCT/SE05/01537

§ 371 Date: Apr. 18, 2007

(30) Foreign Application Priority Data
Oct. 19, 2004 (SE) 0402523-5

(51) Int. Cl. H01P 1/20

(52) U.S. Cl. 333/202

(57) ABSTRACT

The present invention relates to a RF filter made from Zink or a Zink alloy, preferably used for extracting a DC voltage and/or a low frequency signal (DC/Com, signal) superimposed on a RF signal. The DC/Com, signal is extracted using a low pass filter which is arranged inside the first resonator inside the filter. Preferably, the low pass filter is a tubular filter.

### TECHNICAL FIELD

The present invention relates to a filter as defined in the preamble of claim 1, preferably having an arrangement for extracting a DC or low frequency signal superimposed on a RF signal.

### BACKGROUND TO THE INVENTION

Often a DC voltage and a low frequency communication signal are superimposed on a RF signal fed into a filter for mobile communication. The DC voltage may be used to drive a low noise amplifier (LNA) in the filter and the low frequency communication signal contains information that is used internally in the filter, sent from the filter or passed through the filter, together or not with the DC voltage, without being distorted by the transfer function of the filter.

To be able to realise this, the DC voltage together with the low frequency communication signal have to be removed from the input signal before the RF signal enters the filter structure, and, if desired, the DC voltage and/or the low frequency communication signal may be added to the output of the filter.

Several solutions have been proposed during the years and FIGS. 1 and 2 disclose solutions which are described in more detail below. The principal function of the arrangement for extracting the DC voltage and the low frequency communication signal comprises a low pass filter (LP filter) arranged in parallel with an input coupling rod or first resonator. Both solutions described in FIGS. 1 and 2 have similar drawbacks, since they are difficult to produce in a reliable and stable way. There are risks for passive inter modulation (PIM) and it is difficult to control the tolerances of the structure which limits performance and makes the solutions described in connection with FIGS. 1 and 2 expensive to manufacture. Furthermore, RF tends to leak into the DC voltage and the low frequency communication signal due to the structure of the LP filter.

A structure similar to the claimed invention is disclosed in U.S. Pat. No. 5,023,579 by Salvatore et al., that describes an integrated band pass/low pass filter where the first and last resonators are coupled to associating connectors. Low pass filters are positioned within the first and last resonators and the RF signal fed into the resonators are subject to low pass filtration thus forming a band pass filter for the RF signal. Thus the RF signal is subject to low pass filtering which is not the object of the invention.

### SUMMARY OF THE INVENTION

The object of the invention is to provide a new way to produce a filter housing resulting in a more compact filter compared to prior art solutions.

A solution to the purpose is achieved by a filter as defined in the characterising portion of claim 1.

An advantage with the inventive filter is that it is possible to reduce the required tolerances in the manufacturing process which in turn will minimise the size of the internal structure of the filter, and furthermore, the inventive filter makes it possible to integrate e.g. threaded connectors in the filter housing during casting.

An advantage with a preferred embodiment of the filter is that it is easier to cast the housing in Zink or Zink alloy compared to casting in Aluminium, which will increase the life time of the tools needed when casting the housing.

The invention will now be described in connection with the attached drawings, which are provided in a non-limited way, to enhance the understanding of the invention.

### BRIEF DESCRIPTION OF THE DRAWINGS

FIG. 1 shows a first prior art arrangement for extracting DC voltage or low frequency signals superimposed on a RF signal.

FIG. 2 shows a second prior art arrangement for extracting DC voltage or low frequency signals superimposed on a RF signal.

FIG. 3 shows a first embodiment of a DC extracting arrangement according to the present invention.

FIGS. 4a and 4b show a second and a third embodiment of a DC extracting arrangement according to the present invention.

FIG. 5 shows a fourth embodiment of a DC extracting arrangement implemented in a filter.

FIGS. 6a and 6b show cross-sectional views of the filter in FIG. 5.

FIG. 7 shows a block diagram of a first embodiment of a filter including a DC extracting arrangement.

FIG. 8 shows a block diagram of a second embodiment of a filter including a DC extracting arrangement.

### DETAILED DESCRIPTION OF PREFERRED EMBODIMENTS

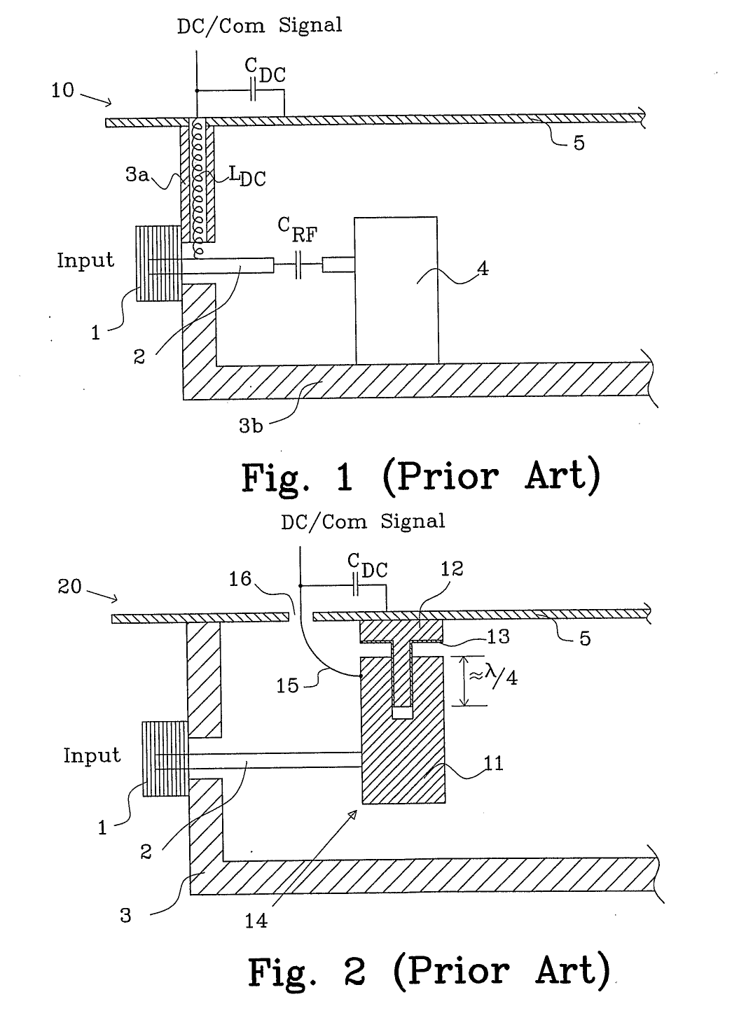

FIGS. 1 and 2 describe prior art solutions for a DC extracting arrangement in a RF filter, where the signal to be extracted (DC voltage or a low frequency signal usually used for communication purposes) is superimposed on a RF signal.

FIG. 1 shows a first type of prior art arrangement for extracting a DC voltage or low frequency signal in a RF filter 10 having a housing 3a, 3b and a lid 5. A common signal, comprising a RF signal with a superimposed DC voltage and/or low frequency signal, is fed into an input connector 1. A connector rod 2 is connected to the input connector 1 and the connector rod 2 is isolated from the filter housing 3a, 3b. A first resonator 4 is capacitively coupled to the input connector 1 via said connector rod 2 and a first capacitor C_{RF}. A first end of an inductor L_{DC} is directly connected to the connector rod 2, usually by soldering, and a second end of the inductor L_{DC} is connected to a second capacitor C_{DC}, which is located outside of the RF filter 10. The inductor L_{DC} is located inside a part of the filter housing 3a and extends through the filter lid 5, which is secured to the housing by screws or similar fastening means. The inductor L_{DC} and the second capacitor C_{DC} together forms a low pass filter (LP filter), and the DC voltage and/or the low frequency communication signal (DC/Com. Signal) is available on the outside of the filter. The second capacitor C_{DC} may be implemented on a PCB (not shown) attached to the filter lid 5.

There are drawbacks with the described DC extracting arrangement, especially concerning leakage of the RF signal into the DC/Com signal. Furthermore, the connection of the first end of the inductor L_{DC} is difficult to achieve due to the small space available for soldering it to the connector rod 2.

The second type of DC arrangement shown in FIG. 2 also comprises a filter 20, having a housing 3 and a lid 5, an input connector 1 connected to a connector rod 2. The lid 5 is secured to the housing 3 in a similar as described in connection with FIG. 1, and a first resonator 14 is located inside the filter 20.

The connector rod 2, which isolated from the housing 3, is directly connected to an isolated part 11 of the first resonator 14, which means that the common signal, comprising the RF signal with the superimposed DC voltage and/or low frequency signal, is fed into the input connector 1 via the connector rod 2 to the isolated part 11 of the first resonator 14. The first resonator further comprises a base part 12, which is electrically grounded to the lid 5 and isolated from the isolated part 11 by an isolating layer 13. A capacitor C_{RF} is thus created.

An end of a wire 15, acting as an inductor L_{DC}, is connected to the isolated part 11 of the first resonator 14, and the wire 15 is arranged through a hole 16 in the lid 5. The second end of the wire is connected to a second capacitor C_{DC}, which is located outside of the RF filter 20. The second capacitor C_{DC} may naturally be implemented on a PCB (not shown) if desired. The inductor L_{DC} and the second capacitor C_{DC} forms, as described in connection with FIG. 1, a low pass filter.

The second type of prior art DC extracting arrangement also has drawbacks, especially regarding RF leakage in the DC/Co. signal, but also in the complex structure of the DC extracting arrangement where soldering of the wire to the first resonator 14 is necessary to obtain a good contact.

The basic idea of the invention, as described below, is to arranged the LP filter inside the first resonator and couple the RF signal to the outside of the first resonator. This will in turn suppress the RF signal in the DC/Com. Signal, but also provide a simplified manufacturing process of the filter.

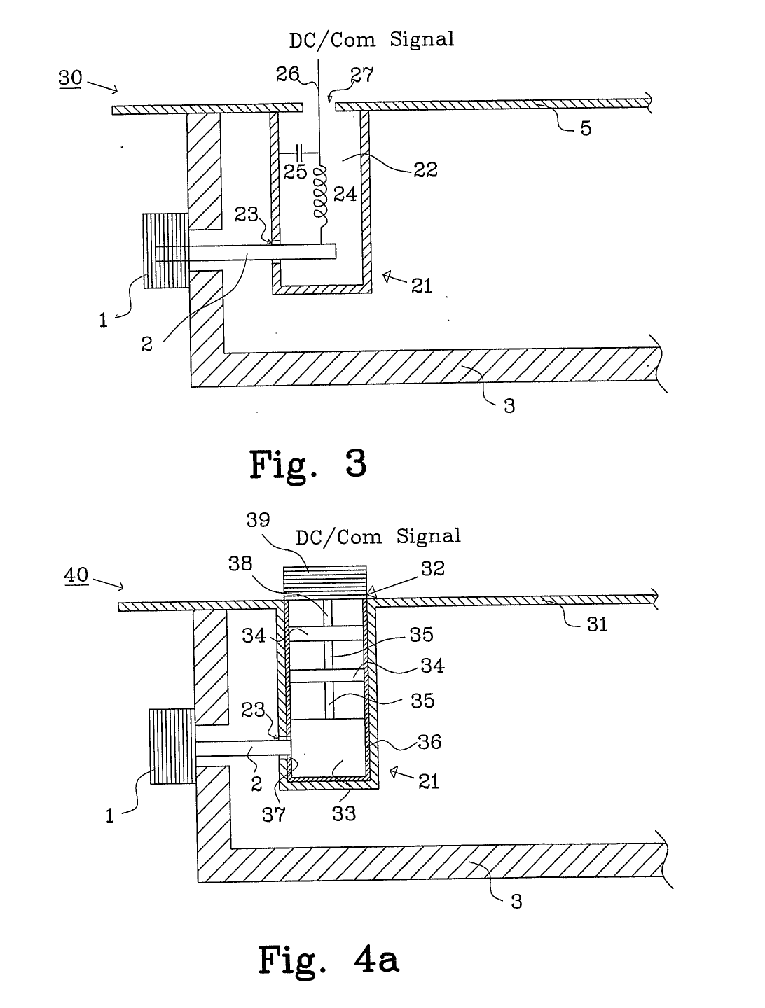

FIG. 3 shows a first embodiment of a DC extracting arrangement according to the present invention arranged in a filter 30, having a housing 3 and a lid 5. An input connector 1 and a connector rod 2, isolated from the housing 3, are provided to feed the common signal, comprising the RF signal with the superimposed DC/Com. signal, into the filter 30.

A resonator 21, which could be the first resonator in a filter structure or a coupling rod for several filter structures, is provided with a cavity 22. The resonator 21 is electrically grounded to the filter lid 5 and the coupling rod 2 extends through an opening 23 in the resonator 21 into the cavity 22. A low pass filter (LP filter) comprising an inductor 24 and a capacitor 25 are provided inside the cavity 22 and the DC/Com. signal is fed out from the cavity 22, through an opening 27 in the filter lid 5.

The LP filter is realised by connecting a first end of the inductor 24 with the end of the connector rod 2 extending into the cavity 22. The second end of the inductor 24 is connected in series with the capacitor 25, which is grounded to the cavity wall, and the DC/Com. signal is extracted by connecting a wire 26 to the second end of the inductor 24 and leading it through the opening 27 in the filter lid 5.

The described embodiment illustrates the basic idea of the invention and the FIG. 4a describes a preferred embodiment of the present invention.

In FIG. 4a similar features have the same reference numerals as previously used. The major difference between the previously described embodiment in FIG. 3 is that the LP filter is realised as a tubular LP filter 32. The connector rod 2 is conductively attached to the lower part 33 of the tubular LP filter 32 and an isolating layer 36, e.g. PTFE or Teflon, is provided between the tubular LP filter 32 and the cavity wall. An opening 37 in the isolating layer 36 is provided to facilitate the attachment of the conductor rod 2 to the lower part 33 of the tubular LP filter 32.

The tubular LP filter 32 further comprises, in this embodiment, two discs 34, where the discs and the lower part 33 are interconnected with thin rods 35. Each disc will create a capacitance to the cavity wall and each thin rod will create a inductance, thus creating a LP filter. The DC/Co. signal is retrieved at the centre 38 of the upper end of the tubular LP filter.

In this embodiment the filter is provided with a modified lid 31 which has the resonator 21 integrated with the lid 31 and furthermore, a DC connector 39 is provided on the outside of the lid 31 to which the LP filter output 38 is connected.

FIG. 4b shows a third embodiment of the present invention. The embodiment in FIG. 4b essentially works similar to the embodiment shown in FIG. 4a, and as in FIG. 4a similar features have the same reference numerals as previously used. As in FIG. 4a, the LP filter is realised as a tubular LP filter 32. In this embodiment, however, the connector rod 2 is conductively attached to the lower part 33 of the tubular LP filter 32 of the resonator 21 from underneath in the figure instead of from the left side as in FIG. 4a. Further, the isolating layer 36 has been omitted and isolation is instead provided by an air gap between the cavity wall and the discs 34 and the lower part 33. Also, the bottom portion of the cavity wall has been omitted. As in FIG. 4b, the DC/Co. signal is retrieved at the upper end of the tubular LP filter, preferably from the centre of the uppermost disc 34. As in the previous embodiments, the RF signal is coupled the outside of the resonator 21 and can be forwarded to a bandpass filter 41.

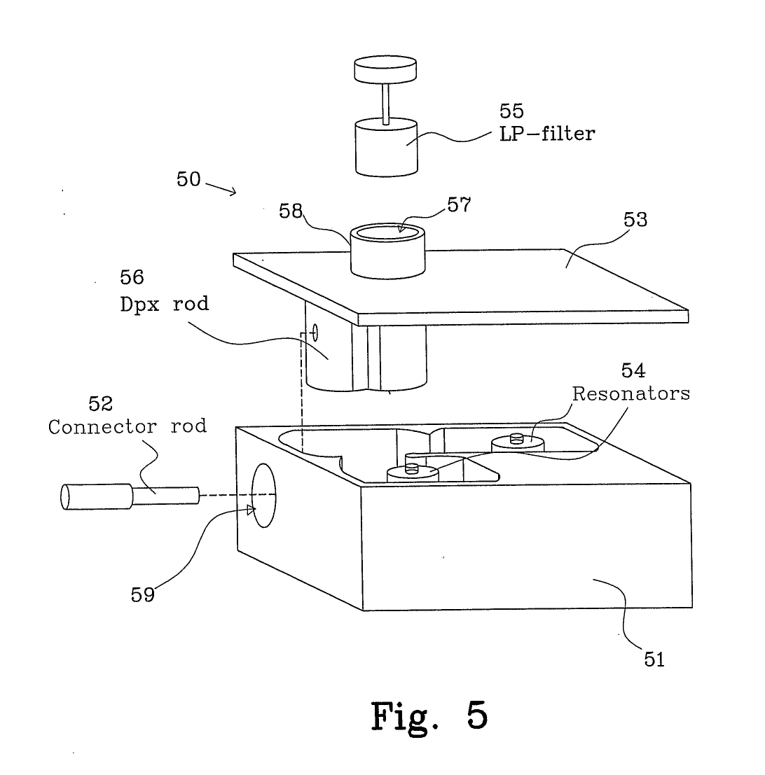

FIG. 5 shows an exploded perspective view of a fourth embodiment 50 of a filter having a DC extracting arrangement according to the present invention. The filter comprises five different parts: filter housing 51, a connector rod 52, a filter lid 53, resonators 54 and LP filter 55.

A coupling rod 56, having a cavity 57, is integrated with the filter lid 53, as described in connection with FIG. 4a, but in this embodiment the edge of the coupling rod stretches through the lid 53 to form a rim 58 on the outside of the filter. An isolating layer (not shown) is mounted inside the cavity 57 to prevent short circuiting of the LP filter 55 when it's mounted inside the cavity. The filter housing 51 is provide with an opening 59 for inserting the conductor rod 52 when attaching it to the LP filter 57 after the resonators 54 and the lid 53 have been mounted to the housing 51.

The filter lid may also be provided with a tuning means, such as a tuning screw, for tuning the frequency of the coupling rod. The tuning means is accessible from the outside of the filter when mounted.

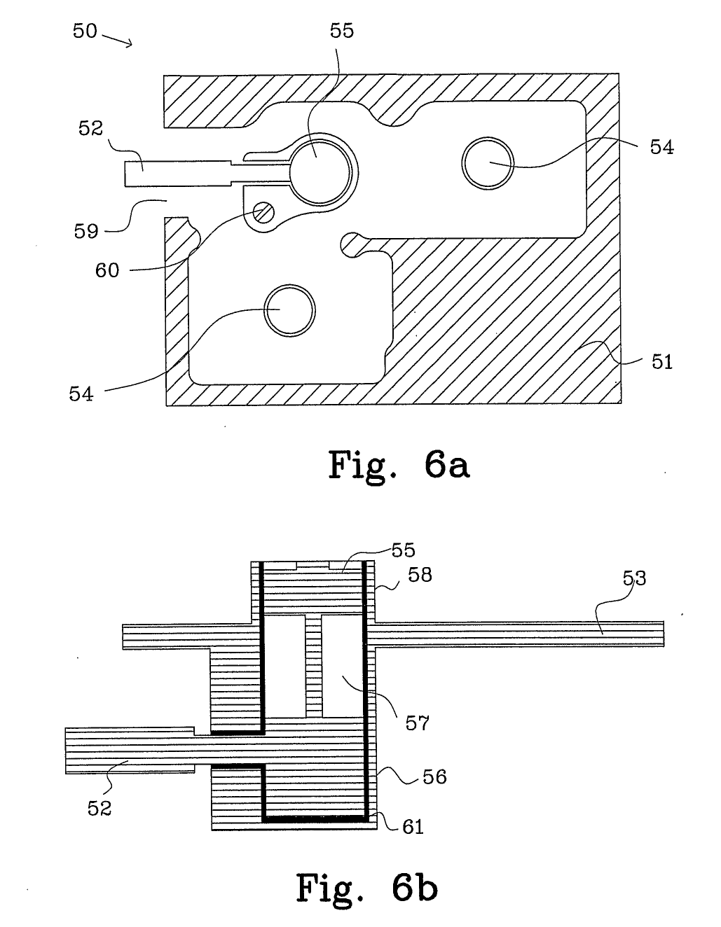

FIGS. 6a and 6b show cross-sectional views of the filter in FIG. 5. FIG. 6a is a cross-sectional top view of the filter where the tuning means 60 is clearly shown. The connector rod 52 is attached to the LP filter in such a way to ensure a good electrical contact, e.g. threads. FIG. 6b shows a partial cross-sectional view of the lid 53 including the mounted LP filter 55 and the connector rod 52. The isolating layer 61 may be seen in the cavity 57 between the LP filter 55 and the integrated coupling rod 56. The isolating layer could be any material that has a dielectric property.

The DC extracting arrangement has only been described as a way to extract low frequency signals, e.g. DC signals or signals having a frequency up to a few MHz (2-4 MHz), but the same arrangement may naturally be used when adding DC and/or low frequency communication signals to a RF signal.

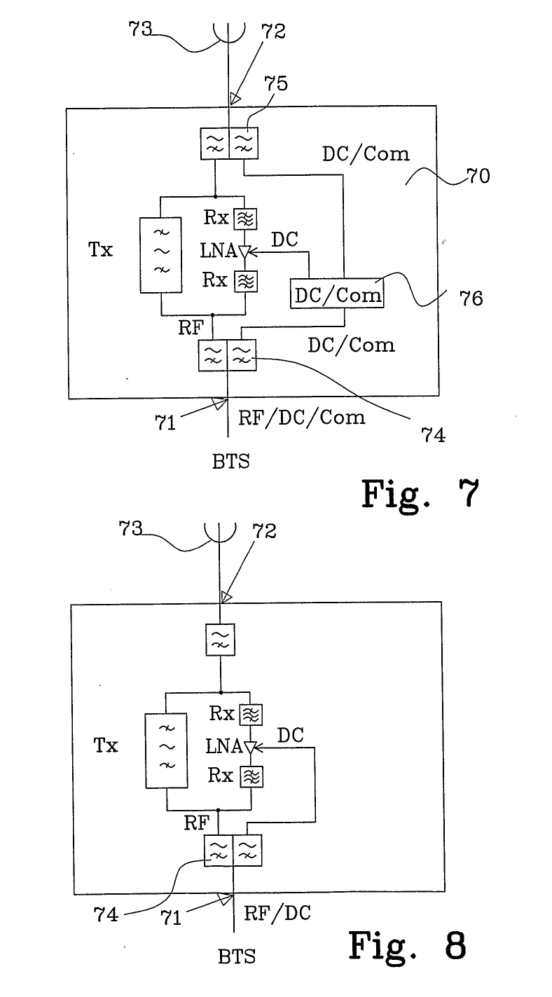

FIG. 7 shows a block diagram illustrating a duplex filter 70 for a mobile telecommunication system. The input 71 of the duplex filter 70 could be connected to a base station (BTS) and the output 72 could be connected to an antenna 73.

The duplex filter 70 comprises: a transmitting filter structure Tₓ; two receiving filter structures Rₓ with a low noise amplifier LNA in between; a DC/Com. signal extracting arrangement 74; and a DC/Com. signal adding arrangement 75.

The LNA requires a DC voltage to operate and that is provided by circuits 76. The low frequency communication signal is normally not used within the duplex filter 70 but is forwarded from the input 71 to the output 72 using the DC extracting and adding arrangements.

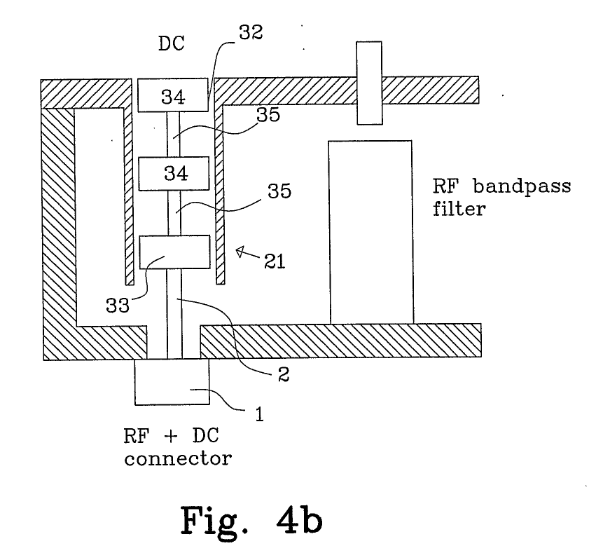

FIG. 8 illustrates a block diagram when no low frequency communication signal is present and the DC voltage only is used to drive the LNA.

The filter shown in FIG. 5 is preferably made from moulded Zink or Zink alloy which makes it possible to reduce the size of the filter housing since thinner walls may be manufactured using Zink or Zink alloy instead of using traditional material as Aluminium. Furthermore, the use of Zink or Zink alloy makes it possible to integrate treaded input and output connectors to the housing. The use of moulded Zink or Zink alloy has the distinct advantage that the moulding takes place at a lower pressure and temperature, compared to Aluminium, which in turn will increase the life time of the moulding tools used during the manufacturing process.

Since it is possible to include complex structures in the moulded filter housing, the result is a much cheaper product compared to traditional filters made from Aluminium.

Furthermore, it is also advantageous to mould the filter lid, including the DC extracting arrangement as described in connection with FIGS. 5, 6a and 6b, in Zink or Zink alloy. The temperature coefficient of both the housing and the lid will then be approximately equal which will increase the performance of the filter during operation. However, the lid is preferably coated with a highly conductive material, such as silver, to increase the performance of the filter.

Zink Alloys that could be Used are:

ZP0410 according to standard EN-1774. This alloy is a good “standard alloy”.

ZP0810 according to standard EN-1774, is also called ZAMAK 8 (ZnAl8Cu1). Stronger than ZP0410 but is more fragile and has a less expansion coefficient.

Other Possible Zink Alloys are:

ZP0400 according to standard EN-1774.

ZP0610 according to standard EN-1774.

1. A filter comprising a filter housing and a filter lid, and at least one filter structure including cavities and resonators, said filter housing being made from Zink or a Zink alloy, wherein the filter housing is integrated with threaded input/output connectors and the walls defining the cavities, there being mounted a the input of the filter a DC extracting arrangement for extracting DC voltage or low frequency signal superimposed on a radio frequency signal (RF signal), said RF signal being fed into a first resonator of the RF filter structure.

2. The filter according to claim 1, wherein said filter housing is cast.

3. The filter according to claim 1, wherein said filter lid is also made from Zink or a Zink alloy, and is coated with silver.

4. The filter according to claim 1, wherein said first resonator of the filter structure is integrated with the lid.

5. The filter according to claim 1, wherein a DC adding arrangement for adding a DC voltage or low frequency signal superimposed on a radio frequency signal (RF signal) is mounted at the output of the filter, said RF signal being fed out from a final resonator of the RF filter structure.

6. The filter according to claim 1, wherein input/output connectors of the filter are made during casting procedure.

7. The filter according to claim 6, wherein the input/output connectors are threaded during the casting procedure.

8. The filter according to claim 1, wherein said extracting arrangement comprises a low pass filter that provides the DC voltage or the low frequency signal outside the RF filter structure, the first resonator being provided with a cavity, said LP filter being arranged inside the cavity of the first resonator, and the RF signal being coupled to the outside of the first resonator.

9. The filter according to claim 8, wherein said first resonator of the extracting arrangement is integrated with the filter lid or the filter housing.

10. The filter according to claim 8, wherein a tuning means for tuning the frequency of the first resonator of the extracting arrangement is integrated in the first resonator.

11. The filter according to claim 10, wherein the tuning means is a tuning screw.

12. The filter according to any of claims 8 to 11, wherein the first resonator of the extracting arrangement is a coupling rod providing RF signals to a first filter structure (Rₓ), and receiving RF signals from a second filter structure (Tₓ).

13. The filter according to claim 5, wherein said adding arrangement comprises a low pass filter (LP filter) that superimposes the DC voltage or the low frequency signal provided from the outside the RF filter structure to the RF signal, the final resonator being provided with a cavity, said LP filter being arranged inside the cavity of the final resonator, and the RF signal being coupled to the outside of the final resonator.

14. The filter according to claim 13, wherein said final resonator of the adding arrangement is integrated with the filter lid or the filter housing.

15. The filter according to claim 13, wherein a tuning means for tuning the frequency of the final resonator of the adding arrangement is integrated in the final resonator.

16. The filter according to claim 15, wherein the tuning means is a tuning screw.

17. The filter according to claim 13, wherein the final resonator of the adding arrangement is a coupling rod receiving RF signals from a first filter structure (Rₓ), and providing RF signals from a second filter structure (Tₓ).

18. The filter according to claim 8, wherein said low pass filter is a tubular filter.

19. The filter according to claim 18, wherein the tubular filter is made from a single piece of material.
